(19) United States
(12) Patent Application Publication
(10) Pub. No.: US 2005/0170676 A1
(43) Pub. Date: Aug. 4, 2005

(54) Battery charger

(76) Inventors: Chien Shen Yuan, Hsin-Tien City (TW); Chen Chun Hsien, Hsin-Tien City (TW); Chan Ming Che, Hsin-Tien City (TW)

Correspondence Address: HDSL, 4331 STEVENS BATTLE LANE, FAIRFAX, VA, 22033, US

(21) Appl. No.: 10/770,454

(22) Filed: Feb. 4, 2004

(51) Int. Cl. H01R 12/00

(52) U.S. Cl. 439/76.1

(57) ABSTRACT

A battery charger has at least one seat, a charging slot with an interior step configuration to divide the charging slot into two plug-in regions. A circuit device is installed in the seat. The circuit device has at least one conductive terminal, which has to contact parts located at two plug-in regions. The charger further has a positioning base for mounting the seat thereon. By forming two charging slots with each two plug-in regions, the charging slot allows two batteries with different sizes and specifications to be charged at the same time. As the positioning base is easily fabricated with various dimensions, the battery charger can be expanded with a plurality of charging slots. In addition, the charger is easily assembled and utilized.

### BACKGROUND OF THE INVENTION

The present invention relates in general to a battery charger, and more particularly, to a battery charger operative to charge two batteries with different dimensions and specifications.

Currently, upon purchase of a palm computer or other electronic devices, a standardized battery and charger are provided. Therefore, when the battery is exhausted, it can be recharged and reused again. However, as the battery for each electronic device has a unique specification, the charger is different. Especially for the fast updated palm computers, the sizes and configurations of the batteries accompanying the new models of computers are continuously changed. Therefore, the chargers made by different brands or even models cannot be used. The incompatibility is very inconvenient for the user.

Further, the conventional charger is operative to charge one battery at once. Therefore, a lot of time is required when more than one battery is to be charged. Further, if the batteries are in different shapes and sizes, more than one charger is required. It is thus very inconvenient and uneconomic for the user.

### SUMMARY OF THE INVENTION

The present invention provides a battery charger operative to charge two batteries with different sizes and specifications at the same time, such that the practicability is enhanced.

The present invention further provides a battery charger which has an expandable charging slot for charging multiple batteries simultaneously.

The charger provided by the present invention comprises at least one seat, and a charging slot in the seat. The charging slot includes an interior step which divides the charging slot into two plug-in regions. In one embodiment, the plug-in region under the step is operative to receive and charge a battery with a thinner dimension, while the plug-in region over the step is operative to receive and charge a battery with a thicker dimension therein. The seat further includes a circuit device in electric communication with an external power source. The circuit device includes a conductive terminal, which further comprises two contact parts located at the respective plug-in regions. Thereby, the external power source can be applied to the plug-in regions for charging two batteries with either thinner or thicker dimensions simultaneously.

The charger further comprises a positioning base. The positioning base has a U-shape cross section. The positioning base can be easily fabricated in various shapes and dimensions. Therefore, when a plurality of charging slots is required, a plurality of seats can be installed in the positioning base in parallel.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF ACCOMPANIED DRAWINGS

The above objects and advantages of the present invention will be become more apparent by describing in detail exemplary embodiments thereof with reference to the attached drawings in which:

FIG. 1 is an exploded view of a battery charger;

FIG. 2 is a perspective view of a battery charger;

FIG. 3 is a front view of the battery charger;

FIG. 4 is a side view of the battery charger;

FIG. 5 shows two batteries with different sizes to be charged;

FIG. 6 is a cross sectional view showing the batteries as shown in FIG. 5 plugged in the charging slot;

FIG. 7 is an exploded view of a battery charger in another embodiment;

FIG. 8 shows a perspective view of the battery charger a shown in FIG. 7; and

FIG. 9 shows the operation status of the battery charger as shown in FIG. 7.

### DETAILED DESCRIPTION OF EMBODIMENT

Reference will now be made in detail to the preferred embodiments of the present invention, examples of which are illustrated in the accompanying drawings. Wherever possible, the same reference numbers are used in the drawings and the description to refer to the same or like parts.

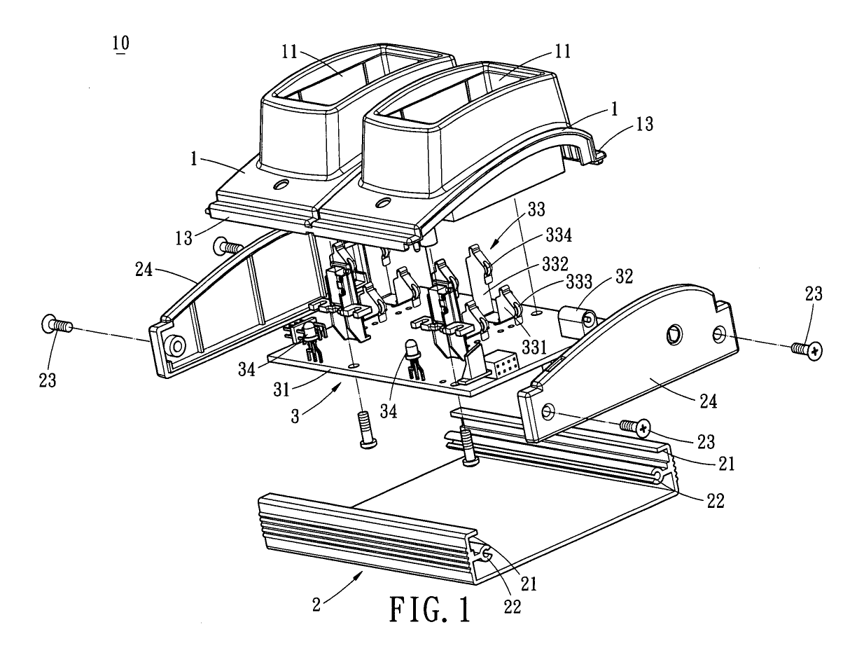

The present invention provides a battery charger applicable in various electronic devices such as a palm computer. As shown in FIG. 1, the battery charger 10 includes at least one seat 1. In this embodiment, the battery charger 10 includes two parallel seats 1 mounted on a serially connectible positioning base 2.

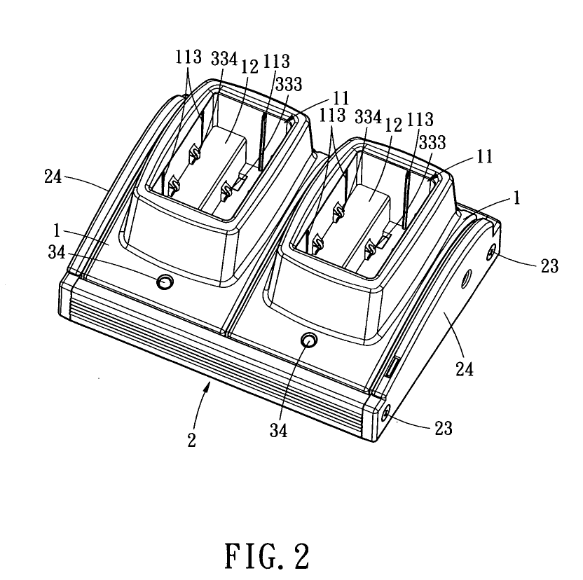

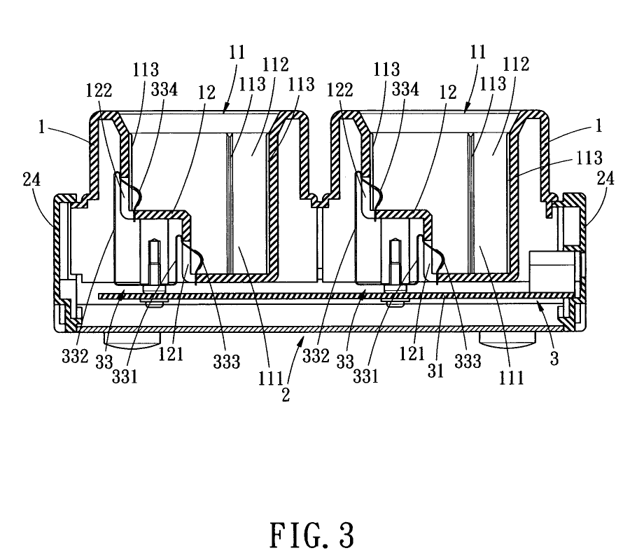

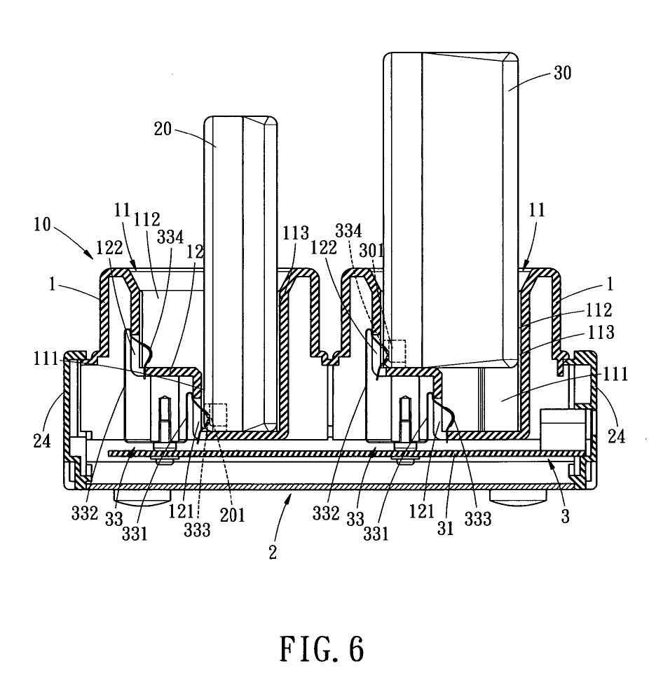

As shown in FIGS. 2-3, each of the seats 1 includes a charging slot 11. The charging slot 11 has a step 12 which divides the charging slot 11 into a lower plug-in region 111 and an upper plug-in region 112. The lower plug-in region 111 has a width smaller than that of the upper plug-in region 112. Therefore, as shown in FIG. 6, the lower plug-in region 111 is operative to charge a battery 20 with a thinner dimension, while the upper plug-in region 112 is operative to charge a battery 30 with a thicker dimension. The step 12 includes openings 121 and 122 in the sidewalls at the lower and upper plug-in regions 111 and 112, respectively. The charging slot 11 further includes a plurality of ribs 112 formed on four sidewalls thereof, such that when the batteries 20 and 30 are plugged into the charging slot 11 at the plug-in regions 111 and 112, a frictional fit between the batteries 20 and 30 and the charging slot 11 stably secure the batteries 20 and 30 in the charging slot 11.

Referring to FIGS. 1 and 3, each of the seats 1 further comprises a circuit device 3, which includes a circuit board 31, a socket 32 formed on the circuit board 31 to be in electric communication with an external power source, and a plurality of conductive terminals 33. In this embodiment, two charging slots 11 are formed in respective the seats 1, and each charging slot 11 has two conductive terminals 33 and two indicators 34 to indicate the charging condition of the respective plug-in regions 111 and 112.

In an exemplary embodiment, the conductive terminals 33 are in a U shape with a short arm 331 and a long arm 332. The tips of the short and long arms 331 and 332 are bent externally to form contact parts 333 and 334, respectively. The contact part 333 of the short arm 331 is exposed in the lower plug-in region 111 through the opening 121, while the contact part 334 of the long arm 332 is exposed in the upper plug-in region 112 through the opening 122. Thereby, the batteries 20 and 30 with different sizes plugged in the plug-in regions 111 and 112 can be connected to the power source via the contact parts 333 and 334, respectively.

As shown in FIG. 1, the seats 1 are mounted to a positioning base 2 which can be formed by aluminum extrusion, for example. The positioning base 2 has a U cross-sectional shape. The top surface of the positioning base 2 has a snap-fit portion 21, while the seats 1 each includes a positioning part 31 corresponding to the snap-fit portion 21. By the engagement of the snap-fit portion 21 and the positioning parts 31, the seats 1 are fitted on the positioning base 2. The positioning base 2 further comprises a pair of C-shape latching parts 22 integrally formed on two sidewalls thereof, and two lids 24 covering two opposing sides thereof by fastening devices 23.

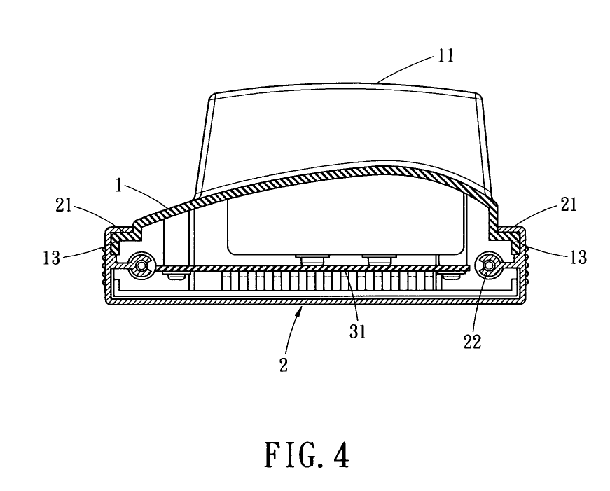

Referring to FIG. 4, while installing the integrally formed seats 1 onto the positioning base 2 with a specific length, the positioning parts 13 of the seats 1 are engaged with the snap-fit portions 21 of the positioning base 2. Meanwhile, two sides of the positioning base 2 are covered by the lids 24, which are then fastened by engaging the fastening devices 23 with the latching parts 22. Thereby, a battery charger with two charging slots 11 is assembled.

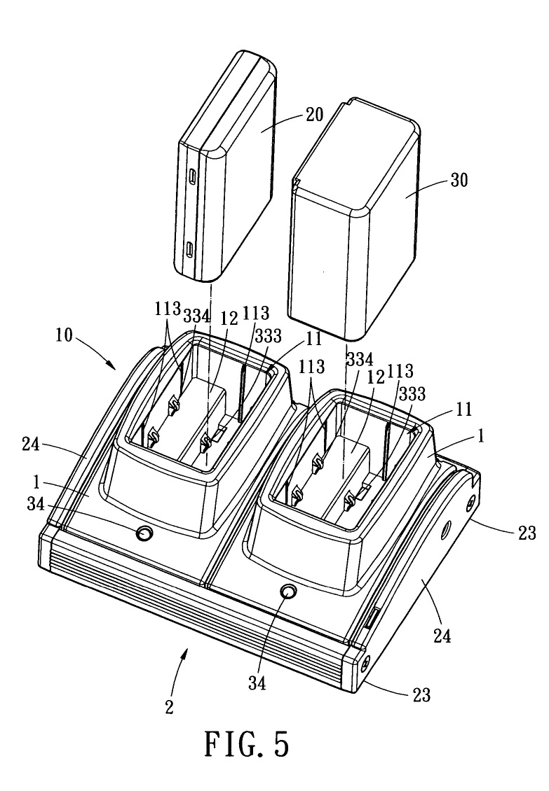

As shown in FIGS. 5 and 6, as the charger 11 has two charging slots 11, two batteries 20 and 30 with different sizes and specifications can be charged simultaneously. That is, the thinner battery 20 can be plugged and charged in the lower charging slot 111, while the thicker battery 30 can be plugged and charged in the upper charging slot 112 at the same time. The node 201 of the battery 20 is in contact with the contact part 333 of the short arm 33 of the conductive terminal 33. Thereby, the external power source is applied to the battery 20 via the conductive terminal 33. The thicker battery 30 is plugged and charged in the upper plug-in region 112 with the same dimension similar thereto. The node 301 of the battery 30 in the upper plug-in region 112 is in contact with the contact part 334 of the long arm 332 of the conductive terminal 33. Thereby, the external power source can be applied thereto.

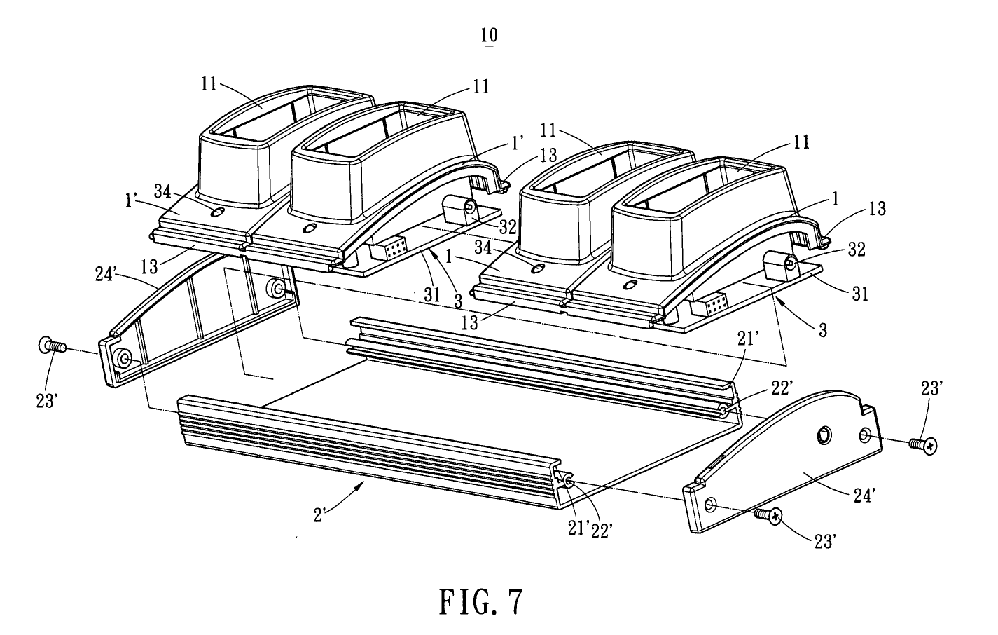

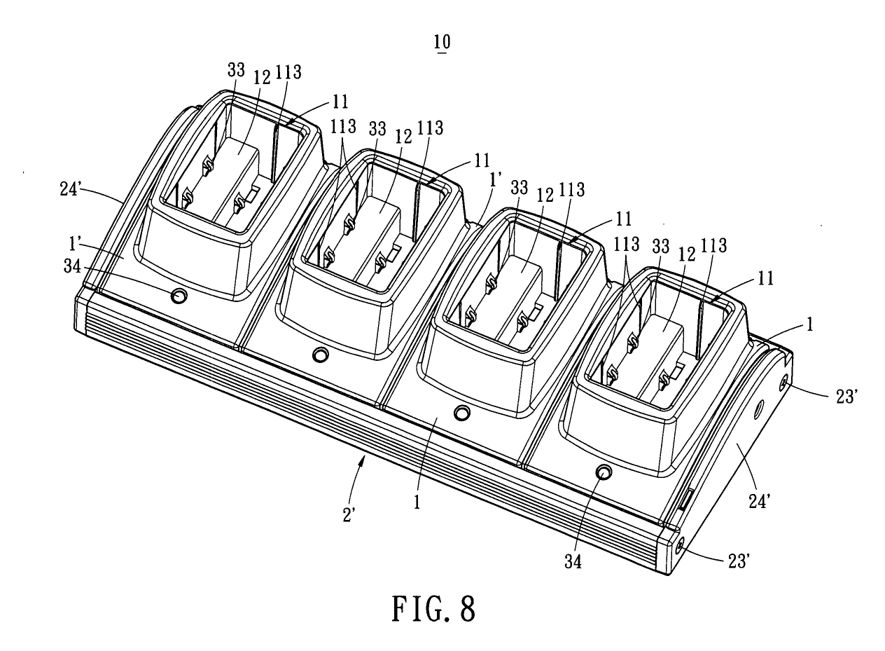

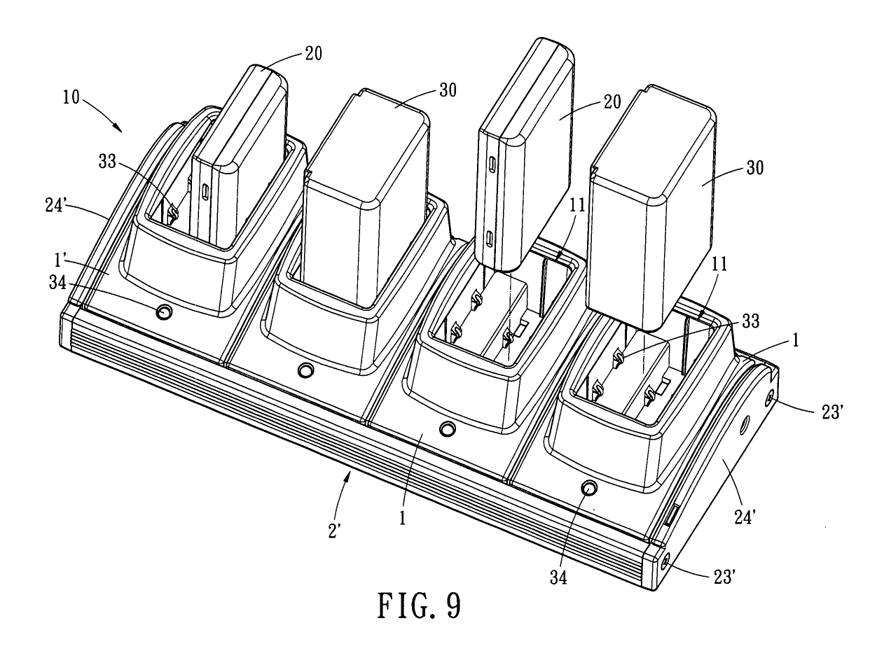

FIGS. 7-8 show another embodiment of a charger which has four charging slots 11 applicable to a positioning base 2′ with a proper dimension. The positioning portions 13 of two sets of seats 1 and 1′ are engaged with the snap-fit parts 21′ of the positioning base 2′. Similarly, two sides of the positioning base 2 are covered by the lids 24′ which are secured to the positioning base 2 by engaging the lids 24′ with the C-shape latching parts 22′. Thereby, the sets of seats 1 and 1′ can be mounted to the same positioning base 2′ to expand the charger with 4 charging slots 11.

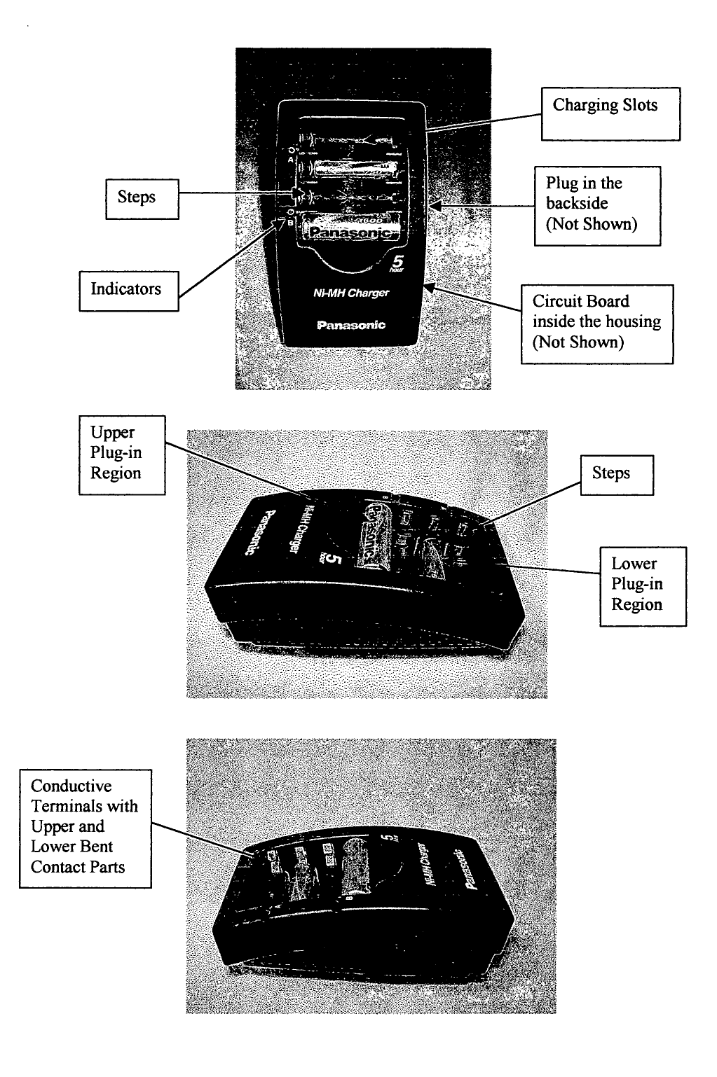

Referring to FIG. 9, as the charger has four charging slots 11, four batteries 20 and 30 can be charged at the same time. Further, each charging slot 11 is divided into a lower charging region 111 and an upper charging region 112, such that two batteries 20 and 30 with different dimensions can be charged by one charging slot 11 simultaneously.

Accordingly, the charging slot 11 of the battery charger 10 provided by the present invention is divided into to the lower and upper plug-in regions 111 and 112 to simultaneously charge two batteries 20 and 30 with different sizes and specifications. The applicability of the battery charger 10 is thus greatly enhanced.

As the positioning base 2 is fabricated by aluminum extrusion, it is very easy to make the positioning base with various desired lengths and dimensions. Therefore, when a plurality of charging slots 11 is required, a plurality of seats 1 can be mounted to the same positioning 2 with a specific length. It is thus very easy to expand the charging slots 11 of the battery charger 10.

While the present invention has been particularly shown and described with reference to preferred embodiments thereof, it will be understood by those of ordinary skill in the art the various changes in form and details may be made therein without departing from the spirit and scope of the present invention as defined by the appended claims.

1-7. (canceled)

8. An expandable battery charger, comprising:
a seat, which is parallel linkable with other seat, having a charging slot therein, the charging slot includes a step to divide the charging slot into a lower plug-in region and an upper plug-in region;
a circuit device installed in the seat, wherein the circuit device comprises a circuit board, a socket formed on the board to electrically connect an external power source, and a plurality of conductive terminals to be electrically connected with batteries plugged in charging slot; and
a positioning base for installing the seat therein, wherein the positioning base is formed by aluminum extrusion and includes a pair of lids at two 5 opposing sides thereof.

9. The charger as claimed in claim 8, wherein each conductive terminal is split into a short arm and a long arm each terminated with a bent contact part, the contact part of the short arm is exposed in the lower plug-in region and the contact part of the long arm is exposed in the upper plug-in region.

10. The charger as claimed in claim 9, wherein the step includes two openings at the lower and upper plug-in regions.

11. The charger as claimed in claim 8, wherein the lower plug-in region is narrower than the upper plug-in region.

12. The charger as claimed in claim 8, wherein the seat further comprises an indicator to indicate charging condition of the batteries.

13. The charger as claimed in claim 8, wherein the positioning base includes a snap-fit part formed on a top surface thereof and the seat includes a positioning part engageable with the snap-fit part, such that the seat is snap-fitted to the positioning base.

14. The charger as claimed in claim 13, wherein the positioning base includes a pair of C-shape latching parts extending at two opposing sidewalls thereof.

15. The charger as claimed in claim 8, wherein the charging slot includes a plurality of ribs formed on sidewalls thereof to secure the batteries in the charging slot by frictional fit.
